(19) United States
(12) Patent Application Publication
(10) Pub. No.: US 2008/0287554 A1
(43) Pub. Date: Nov. 20, 2008

(54) Dispersions of Inorganic Particulates

(75) Inventors: David Ian Gittins, Cornwall (GB); Rudy Antoine Theofiel Longeval, Ninove (BE); David Robert Skuse, Cornwall (GB)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: Imerys Minerals Limited, Par, Cornwall (PL)

(21) Appl. No.: 11/909,463

(22) PCT Filed: Mar. 24, 2006
(86) PCT No.: PCT/GB2006/001101

§ 371 Date: May 13, 2008

(30) Foreign Application Priority Data
Mar. 24, 2005 (GB) 0506153.6
Nov. 22, 2005 (GB) 0523775.5

(51) Int. Cl. B01J 13/00

(52) U.S. Cl. 516/9

(57) ABSTRACT

A dispersion of a particulate inorganic material comprises a non-aqueous liquid medium containing a particulate inorganic material dispersed therein and an effective amount of one or more dispersing agent which serves to maintain the particulate inorganic material in dispersion in the non-aqueous medium, wherein the particulate inorganic material has an average particle size (d₅₀) less than about 9 μm, the particulate inorganic material is present in the non-aqueous medium in an amount greater than about 70% by weight of the dispersion and the viscosity of the dispersion is less than about 150 Pa·s measured at room temperature on a Bohlin rheometer using a 20 mm cone/plate at a shear rate of 1/sec. A substantially dry particulate inorganic material surface treated with the dispersing agent and optionally one or more hydrophobising surface treatment agent, and capable of forming the said dispersion, is a further feature of the invention.

### FIELD OF THE INVENTION

The present invention relates to dispersions of inorganic particulate materials.

The inorganic particulate materials can, for example, comprise particulate minerals, such as alkaline earth metal carbonates (for example calcium carbonate or dolomite), metal sulfates (for example barite or gypsum), metal silicates, metal oxides (for example titania, iron oxide, chromia, antimony trioxide or silica), metal hydroxides (e.g. alumina trihydrate), kaolin, talc and the like.

The dispersion media are organic, typically non-polar, liquids including a dispersant and optionally other functional additives. The expression “non-aqueous” used herein is not intended to imply necessarily a complete absence of water, but refers to at least a substantial or effective absence of water.

### BACKGROUND OF THE INVENTION

A wide variety of organic chemical based products exists, in which it is desirable to include inorganic particulate materials such as the minerals mentioned above. Such products include, for example, polymers and articles made from polymers, sealants, adhesives, caulks, coatings, toners and inks.

The inorganic material may, for example, serve as a filler, a pigment, a rheology modifier, a performance enhancer, an agent for imparting anti-block properties, an agent for imparting fire retardant or flame retardant properties, an agent for imparting abrasion resistance properties, a source of dye receptor sites to enhance coloration on dying, or any combination thereof.

It is desirable to be able to introduce the inorganic particulate material into a mix in the manufacturing process in the form of a high-solids liquid or slurry dispersion of the particles in a non-aqueous liquid medium.

However, as is well known, for every dispersion system a balance exists between the two desiderata of, on the one hand, maintaining a high solids concentration to assist efficient introduction of the particulate into the mix, and, on the other hand, maintaining a sufficiently low viscosity of the dispersion to achieve efficient handling.

There is a continuing need to be able to increase the solids (mineral) content of particulate dispersions without substantial detriment to the handling performance of the dispersion.

There is also a continuing need to be able to introduce inorganic particulate material either in liquid or slurry form or in substantially dry form into a mix in the manufacturing process and to disperse the particulate material therein with relatively low energy consumption and mixing time.

### BRIEF DESCRIPTION OF THE INVENTION

In a first aspect the present invention provides a dispersion of a particulate inorganic material, the dispersion comprising a non-aqueous liquid medium containing a particulate inorganic material dispersed therein and an effective amount of one or more dispersing agent which serves to maintain the particulate inorganic material in dispersion in the non-aqueous medium, wherein the particulate inorganic material has an average particle size (d₅₀) as herein defined less than about 9 μm and, for example, a BET surface area greater than about 2 m²/g, the particulate inorganic material is present in the non-aqueous medium in an amount greater than about 70% by weight of the dispersion and the viscosity of the dispersion is less than about 150 Pa·s measured at room temperature on a Bohlin rheometer using a 20 mm cone/plate at a shear rate of 1/sec.

The dispersion may include further optional ingredients as desired.

In a second aspect the present invention provides a process for the preparation of the dispersion according to the first aspect, which comprises admixing a particulate inorganic material with the defined non-aqueous liquid medium in the presence of the defined dispersing agent, optionally with any necessary adjustment to the average particle size of the particulate inorganic material, the amount of the particulate inorganic material present and the viscosity of the dispersion, whereby the desired dispersion is obtained.

In a third aspect the present invention provides a dispersion of a particulate inorganic material, prepared or preparable by the process according to the second aspect of the invention.

In a fourth aspect the present invention provides various uses of the dispersion according to the first and third aspects of the invention, or prepared or preparable according to the second aspect of the invention. Such uses are described in more detail below.

In a fifth aspect the present invention provides a substantially dry inorganic particulate material having an average particle size (d₅₀) as herein defined less than about 9 μm and, for example, a BET surface area greater than about 2 m²/g, the material being surface-treated with an amount of one or more dispersing agent which is effective, on dispersion of the particulate inorganic material in a non-aqueous liquid medium in an amount greater than about 70% by weight of the dispersion, to maintain the particulate inorganic material in dispersion in the non-aqueous medium, the viscosity of the dispersion being less than about 150 Pa·s measured at room temperature on a Bohlin rheometer using a 20 mm cone/plate at a shear rate of 1/sec. The expression “substantially dry” used herein refers especially to particles that are not entrained in a carrier liquid, but are typically free flowing or compactable together or sticky. Such a material may, for example, be used in the process according to the second aspect of the invention, or may be used as a dry ingredient in the manufacture of organic chemical based products comprising a particulate inorganic material.

The dispersion according to the present invention may consist essentially of the particulate inorganic material, the non-aqueous liquid medium and the dispersing agent, together with less than about 15% by weight, more particularly less than about 10% by weight, for example less than about 5% by weight, of other components.

The particulate inorganic material used in the invention may if desired be (additionally) surface treated with one or more hydrophobising surface treatment substances.

### DETAILED DESCRIPTION OF THE INVENTION

### The Particulate Inorganic Material

The particulate inorganic material may suitably be a particulate natural, synthetic or blended mineral such as, for example, an alkaline earth metal carbonate (for example calcium carbonate or dolomite), metal sulfate (for example barite or gypsum), metal silicate, metal oxide (for example titania, iron oxide, chromia, antimony trioxide or silica), metal hydroxide (e.g. alumina trihydrate), kaolin, calcined kaolin, wollastonite, bauxite, talc or mica or any mixture or combination thereof.

The particulate inorganic material in the dispersion according to the invention has an average particle size (weight averaged mean equivalent spherical diameter or d₅₀) less than about 9 μm, for example less than or equal to about 8 μm, for example less than or equal to about 7 μm, for example less than or equal to about 6 μm, for example less than or equal to about 5 μm, for example less than or equal to about 4 μm, for example less than or equal to about 3 μm, for example less than or equal to about 2 μm, for example between about 1.0 μm and about 2.0 μm. Typically, the d₅₀ of the particulate inorganic material may be at least 0.1 μm, for example greater than 0.5 μm.

The d₅₀ of the particulate inorganic material is the particle size (equivalent spherical diameter) at which 50% by weight of the particles are smaller and 50% by weight of the particles are larger. All particle size values specified herein are measured by the well known conventional method employed in the art of sedimentation of the particles in a fully dispersed state in an aqueous medium using a Sedigraph 5100 machine as supplied by Micromeritics Corporation, USA.

The particle size distribution (psd) of the particulate inorganic material may, for example, be such that between about 60 and about 75% by weight of the particles are of a size less than 2 μm, for example between about 60 and about 70% by weight; between about 20 and about 50% by weight of the particles are of a size less than 1 μm, for example between about 25 and about 40% by weight; and between about 1 and about 10% by weight of the particles are of a size less than 0.25 μm, for example between about 1 and about 7% by weight.

It is preferred that the particulate inorganic material present in the dispersion according to the invention has a d₉₈ equivalent spherical diameter (at which 98% by weight of the particles are finer) less than about 20 μm, for example less than about 10 μm, for example less than about 5 μm.

The particulate inorganic material used in the present invention preferably has a particle size distribution (psd) steepness factor between about 20 and 75, for example between about 30 and about 55, for example between about 35 and about 50, for example between about 39 and about 47. The steepness factor is defined as the ratio of the d₃₀ equivalent spherical diameter (at which 30% by weight of the particles are finer) to the d₇₀ equivalent spherical diameter (at which 70% by weight of the particles are finer), multiplied by 100.

The particulate inorganic material used in the present invention may have a BET surface area greater than about 2 m²/g, for example greater than about 3 m²/g, for example greater than about 4 m²/g, for example between about 3.0 and about 5.0 m²/g, particularly between about 4.0 and about 5.0 m²/g. The BET surface area is for example not greater than about 6 m²/g. The BET surface area was measured on a FlowSorb II 2300 machine (Micromeritics).

The calcium carbonate particles may be obtained from a natural source by grinding or may be prepared synthetically by precipitation (PCC), or may be a combination of the two, i.e. a mixture of the naturally derived ground material and the synthetic precipitated material.

Ground calcium carbonate (GCC) is typically obtained by grinding a mineral source such as chalk, calcite, marble or limestone which may be followed by a particle size classification step in order to obtain a product having the desired degree of fineness. The grinding process may be carried out in a dry state (“dry grinding”), in the absence of added hygroscopic or hydrophilic chemicals. This ensures that the surfaces of the ground particles are “clean”, and do not have adhering to them any of the chemicals which may be used in a wet grinding process. The surfaces of the particles are therefore in a suitable state to be dispersed in the non-aqueous medium. By “dry grinding” herein, is meant that the grinding process is carried out in the presence of 10% or less water. Grinding agents may be used in dry grinding, examples of which include propylene, ethylene glycol or triethanolamine, typically in an amount of less than 1%. The particulate solid material may be ground autogeneously, i.e. by attrition between the particles of the solid material themselves, or alternatively, in the presence of a particulate grinding medium comprising particles of a different material from the calcium carbonate to be ground. Further information regarding the dry grinding of calcium carbonate may be found in, for example the following patent specifications: GB-A-1310222, GB-A-2179268, GB-A-2190016, and EP-A-00510890, the content of each of which is incorporated by reference in its entirety. Alternatively, the particulate inorganic material may be processed wet and then either dried or subjected to solvent exchange.

PCC may be used as the source of particulate calcium carbonate in the present invention, and may be produced by any of the known methods available in the art. TAPPI Monograph Series No 30, “Paper Coating Pigments”, pages 34-35 describes the three main commercial processes for preparing precipitated calcium carbonate which is suitable for use in preparing products for use in the paper industry, but may also be used in the practice of the present invention. In all three processes, limestone is first calcined to produce quicklime, and the quicklime is then slaked in water to yield calcium hydroxide or milk of lime. In the first process, the milk of lime is directly carbonated with carbon dioxide gas. This process has the advantage that no by-product is formed, and it is relatively easy to control the properties and purity of the calcium carbonate product. In the second process the milk of lime is contacted with soda ash to produce, by double decomposition, a precipitate of calcium carbonate and a solution of sodium hydroxide. The sodium hydroxide must be substantially completely separated from the calcium carbonate if this process is to be commercially attractive. In the third main commercial process the milk of lime is first contacted with ammonium chloride to give a calcium chloride solution and ammonia gas. The calcium chloride solution is then contacted with soda ash to produce by double decomposition precipitated calcium carbonate and a solution of sodium chloride.

The process for making PCC results in very pure calcium carbonate crystals and water. The crystals can be produced in a variety of different shapes and sizes, depending on the specific reaction process that is used. The three main forms or morphologies of PCC crystals are acicular (for example, aragonite), rhombohedral and scalenohedral, all of which are suitable for use in the present invention, including mixtures thereof.

Other particulate inorganic materials useful in the present invention, for example metal sulfates (for example barite or gypsum), metal silicates, metal oxides (for example titania, iron oxide, chromia, antimony trioxide or silica), metal hydroxides (e.g. alumina trihydrate), kaolin, calcined kaolin, wollastonite, bauxite, talc or mica, may suitably be prepared by known comminution methods which will be well known to those skilled in this art.

The inorganic particulate material may be surface treated with one or more hydrophobising agent which, for example, may have long hydrophobic hydrocarbon chains extending from the particle surface and chemically anchored thereto. The term “long hydrocarbon chains” refers particularly to alkyl and alkenyl chains having at least about 12, for example from about 12 to about 25, for example about 15 to about 18, carbon atoms in the alkyl or alkenyl chain. The hydrophobising surface treatment of mineral particulates is known, and need not be described in great detail. Examples of such surface treatment agents include fatty acids and amines incorporating long hydrocarbon chains, such as stearic acid, oleic acid, lauric acid, palmitic acid and any combination thereof, as well as salts thereof such as sodium or potassium salts. These agents are suitably dry or wet coated onto the inorganic particles prior to mixing the particles with the non-aqueous medium. Such coating processes are well known in the art and do not need to be described here. The anchoring part of the surface treatment agent is selected according to the nature of the particulate material; for example, if the surface of the particulate material contains acidic sites, a basic moiety will be selected as the anchoring part of the surface treatment agent, whereas if the surface of the particulate material contains basic sites, an acidic moiety will be selected as the anchoring part of the surface treatment agent. Where a wet coating process is used, the particles will suitably be dried before use, to reduce the surface moisture content to a negligible level, e.g. below about 0.8% by weight of the particles as measured by Karl Fisher titration (see, for example, EP-A-1375579 and US-A-2005/0004266, the contents of which are incorporated herein by reference).

To prepare the dispersion, the inorganic particulate material, optionally surface treated as described above, may be introduced into the non-aqueous liquid medium in the form of a particle population having the defined required particle size characteristics, or alternatively a particle population having different size characteristics may be introduced into the non-aqueous liquid medium and the size characteristics of the particle population subsequently adjusted in situ (e.g. by grinding) into conformity with the present invention. Both procedures are well known to those skilled in this art.

The inorganic particulate material (e.g. mineral such as calcium carbonate) is present in the non-aqueous liquid medium in an amount greater than about 70% by weight of the dispersion, for example greater than about 75% by weight of the dispersion, for example greater than about 80% by weight of the dispersion.

### The Non-Aqueous Liquid Medium

The non-aqueous liquid medium used in the present invention can suitably be any organic liquid medium which is stable and inert to the required degree under the conditions of manufacture and use. Single compounds or mixtures of compounds can be used.

The particular non-aqueous liquid medium will depend upon the end usage. The selection will be readily made by those skilled in the art.

For example, where the composition of the present invention is to be used as a plasticiser dispersion for introduction into a polymer or a precursor thereof (including without limitation commercial polymers for forming into articles of manufacture, sealants, adhesives, caulks and all precursors thereof), the non-aqueous liquid is a liquid plasticiser. Further, the precise nature of the plasticiser will depend upon the variety of polymer to which the plasticiser is to be introduced or blended. However, in general, plasticisers are essentially non-volatile and have a solubility parameter close to that of the polymer. Examples of some common plasticisers which are usable in the present invention are: paraffinic oils, such as white oils, aromatic oils, camphor, dialkyl phthalate esters (such as di-isodecyl phthalate, di-isononyl phthalate, di-(2-ethylhexyl) phthalate, di-iso-octyl phthalate, di-2-butoxyethyl phthalate, dibutyl phthalate and dimethyl phthalate), other dialkyl esters (such as di-iso-octyl adipate, dioctyl sebacate and dibutyl sebacate), aromatic phosphates (such as triphenyl phosphate, tritolyl phosphate and trixylyl phosphate), glycols (such as ethylene glycol and propylene glycol), dibenzyl ether, triacetin, Santicizer 8. In the case where the plasticiser dispersion is to be used in conjunction with a polyvinyl chloride polymer, typical plasticisers are the dialkyl phthalate esters, in particular di-isononyl phthalate. As plasticiser in, for example, styrenics compounding, a white oil is typically used, such as Winog 70. White oils are aliphatic petroleum/naphtha distillate fractions which have been purified to remove aromatics, odours and coloured compounds. Further background concerning the nature and use of plasticisers may be found in the handbook, “Plastics Materials”, by J A Brydson, published by Butterworth-Heinemann, 7^{th} Edition, 2000, and in US Patent Application No. 2005/0004266 (Kayano et al), the contents of which are hereby incorporated herein by reference.

When the dispersion is used in the preparation of a coating composition, such as an ink, toner or paint, or as a basis for a coating composition, the non-aqueous liquid may be selected from suitable organic liquids such as, for example, hydrocarbons and halogenated hydrocarbons, for example alkyd resins, aromatic organic solvents such as benzene or mono-, di- or tri-loweralkyl benzenes (e.g. toluene, xylene), white spirit, n-hexane, cyclohexane, chlorobenzene, carbon tetrachloride, and perchloroethylene, or oxygenated solvents, for example alcohols such as n-loweralkyl alcohols (e.g. ethanol and n-butanol) and polyols (e.g. glycerol), ketones such as diloweralkyl ketones (e.g. methyl ethyl ketone), ethers such as diloweralkyl ethers, esters such as loweralkyl loweralkanoates (e.g. butyl acetate), and glycols such as ethylene glycol and propylene glycol, or any combination thereof may be used, the term “loweralkyl” and like terms referring preferably to straight or branched alkyl groups having from 1 to about 6 carbon atoms. Generally speaking, the polarity (dielectric constant) of the solvent for these uses may need to be varied across a wide range. Components such as ethanol provide for relatively high polarity; components such as hexanes provide for relatively low polarity).

### Dispersing Agents

Dispersing agents suitable for dispersing inorganic (e.g. mineral) particulates in non-aqueous (e.g. organic) liquid media with substantially reduced agglomeration or flocculation are well known in this art, and the selection of a suitable agent for use in the present invention will be well within the ability of one of ordinary skill. The dispersing agent can be a single compound or more than one compound.

Generally speaking, suitable dispersing agents are organic molecules having a first portion which has high affinity for the inorganic particles or with a so-called synergist (i.e. a further substance chemisorbed on the particles to provide an anchor point for the dispersing agent), a second portion which has affinity for (or solubility in or miscibility with) the non-aqueous liquid medium and a third portion whereby the first two portions are linked together. Alternatively, the dispersing agents may be organic molecules having said first and second portions with no third (linking) portion, i.e. the first and second portions may be directly linked together with no intermediate moiety.

One suitable class of dispersing agents are the so-called hyperdispersants. These are generally polymerised (interesterified) hydroxycarboxylic acids in which each molecule typically comprises many long organic carbon chains each containing at least about 12, for example between about 15 and about 25, carbon atoms in the chain, and one or more anchor moieties which associate with sites of the particle surface or of a synergist molecule anchored to the particle surface. Suitable hyperdispersants include poly-hydroxy-(long chain fatty acids) (where “long chain fatty acids” refers particularly to alkyl and alkenyl carboxylic acids having at least about 12, for example from about 12 to about 25, for example about 15 to about 18, carbon atoms in the alkyl or alkenyl chain), such as polyhydroxystearic acids and salts thereof such as sodium or potassium salts. These poly-hydroxy-(long chain fatty acids) are suitably prepared, for example, by polycondensation of a hydroxy-(long chain fatty acid), e-g. a hydroxystearic acid such as 12-hydroxystearic acid.

The hyperdispersants are therefore distinguished from the hydrophobising surface treatment agents for the particulate material by the matrix of interlinked hydrocarbon chains of the hyperdispersants, compared with the single chains of the surface treatment agent molecules.

Examples of commercially available hyperdispersants for use according to the present invention include those of the Solsperse™ (Lubrizol) and Hypermer™ (Uniquema) hyperdispersant ranges. Particular products that may be mentioned include Solsperse 21000 (Lubrizol); Solsperse 3000 (Lubrizol); and Hypermer LP-1 (Uniquema).

The selection of the nature and amount of the dispersant can easily be made from simple chemical considerations of acidity of the anchor sites of the particulate, the nature and amount of any hydrophobising surface treatment agent employed, and the hydrophobic (non-polar) or hydrophilic (polar) character of the non-aqueous liquid medium.

The selection of whether or not a synergist is required with a particular dispersant, and the nature and amount of the synergist, can easily be made from simple chemical considerations of the surface nature of the inorganic particulate material and of the dispersant to be used.

The total dispersing agent/synergist content of the dispersion may, for example, be less than about 30% of the dispersion by weight, for example less than about 10% by weight, for example less than about 5% by weight, for example less than about 3% by weight, for example less than about 2% by weight. The total amount is suitably at least about 0.01% by weight, for example between about 0.2% by weight and about 2% by weight, for example about 1% to about 2% by weight. For any particular dispersing agent and/or synergist, the precise amount required can easily be determined by simple experimentation, for example adsorption experiments using a flow micro-calorimeter, or by the methods described in the Examples below. Generally, the amount required is related to the specific surface area of the particles and the weight of particulate material (“pigment”) present. Therefore, for each dispersant/synergist, a so-called AOWP (amount over weight of pigment) figure can be calculated in known manner, representing as a percentage the weight of dispersant/synergist in grams required to disperse 100 grams of particulate material (pigment).

Generally speaking, the dispersing agent can be introduced directly into the non-aqueous liquid medium of the dispersion or can be pre-coated onto the inorganic particles, or one or more first dispersing agent compounds can be introduced directly into the non-aqueous liquid medium of the dispersion and one or more second dispersing agent compounds, which may be the same as, or different from, or some the same as and some different from, the first compounds, can be pre-coated onto the inorganic particles.

The use of inorganic particles pre-treated with both one or more dispersing agent selected from the class of long chain fatty acids/salts and one or more dispersing agent selected from the class of polyhydroxy-long chain fatty acids/salts is particularly mentioned. This material can suitably be provided as the dry particulate material mentioned above in connection with the fifth aspect of the present invention. Without wishing to be bound by theory, it is considered possible that, in this embodiment, the long chain fatty acids/salts are functioning to some extent as synergists for the polyhydroxy-long chain fatty acids/salts.

### The Dispersion

The dispersion according to the invention may suitably have a viscosity, as measured at room temperature on a Bohlin rheometer using a 20 mm cone/plate at a shear rate of 1/sec, less than about 100 Pa·s, for example less than about 75 Pa·s, for example less than about 70 Pa·s, for example less than about 50 Pa·s, for example less than about 40 Pa·s, for example less than about 25 Pa·s.

The dispersion according to the invention may suitably have a Hegman Gauge value (BS 3900-C6, ISO 1524 or EN 21524) of less than about 100 μm, for example less than about 50 μm, for example less than about 20 μm, for example less than about 5 μm.

The Hegman gauge consists of a steel block into which is machined a groove which is uniformly tapered along its length from 100 μm at one end to zero at the other. A scale denotes the depth of the groove at any point along its length. A portion of the dispersion is placed in the groove at the deep end and a blade used to draw the liquid down the length of the groove. When the gauge is viewed at an angle, it is possible to note the point along the length of the groove where it becomes shallow enough for the pigment particles to protrude above the level of the liquid. The pigment particle size at this point can be read from the scale.

The Hegman Gauge value of a dispersion is thus a measure value of the size of the wetted/dispersed particles, in contrast to the Sedigraph data on the undispersed particles, and provides an indication of the quality of the dispersion.

### Other Optional Components in the Dispersion

Conventional additional ingredients may be included in the dispersion as desired. The selection of the ingredients and their amounts will be well within the capacity of the skilled worker in this art, and does not need to be described in detail.

By way of example, possible additional ingredients that may in particular circumstances be included in the dispersion include: preservatives, antioxidants, thickening agents, anti-setting agents, biocides, organic pigments, inorganic pigments (other than those defined above), dyes, etc.

### Process for Preparation of the Dispersion

In general, the dispersion of the present invention may be made by blending the non-aqueous liquid with the particulate component in conventional manner, with the dispersing agent being introduced either as a pre-treatment of the particulate or including it in the non-aqueous liquid prior to combining with the particulate.

Thus, a first process embodiment of the invention comprises the steps of:

(a) preparing a pre-mix of the non-aqueous liquid and the dispersing agent; and
(b) combining the premix with the particulate to form a dispersion in which the particulate is present in the non-aqueous liquid medium in an amount of greater than about 70 percent by weight of the dispersion.

The amount of dispersing agent added to the non-aqueous liquid will desirably be that amount which has been calculated to be necessary to disperse the intended amount of particulate. Typically, the dispersing agent is added to the non-aqueous liquid and mixed to ensure even distribution of the dispersing agent in the non-aqueous liquid.

The particulate, which may have been pre-treated as described above, is added to the non-aqueous liquid containing the dispersing agent and mixed to disperse the particles.

Other optional ingredients may be introduced at any stage of the mixing process.

In a second embodiment, the process of the present invention comprises:

(a) treating the particulate with the dispersing agent; and
(b) combining the treated particulate with the non-aqueous liquid medium to form a dispersion in which the particulate is present in the non-aqueous liquid medium in an amount of greater than about 70 percent by weight of the dispersion.

The amount of dispersing agent used to treat the particulate may be that amount which has been calculated to be necessary to disperse the intended amount of particulate in the non-aqueous liquid.

### Uses of the Surface-Treated Inorganic Particulate

The surface-treated substantially dry inorganic particulate material which forms one aspect of the present invention has further uses outside the context of a starting material for preparing the low-viscosity dispersions of the invention.

Thus, for example, the surface-treated substantially dry material may be incorporated as such into organic compositions if this is convenient. In particular, it is envisaged that for certain polymer compositions, sealants, adhesives and caulks, it will be useful to mix the surface-treated dry material into the masterbatch during compounding, rather than a non-aqueous liquid dispersion. Alternatively, the surface treated material may be included during the initial polymerisation of the resin.

For further information concerning the use of particulate materials in sealants, adhesives and caulks, please see US Patent Application No. 2005/0004266.

Specific embodiments of the use of non-aqueous dispersions according to the present invention are as follows:

In the case of plasticiser compositions for use in the manufacture of plasticised polymers, for example plasticised PVC, the non-aqueous medium may be predominantly or totally an organic liquid plasticiser such as, for example, a mineral white oil, a long chain diester of a dibasic carboxylic acid, e.g. diisononyl phthalate (DINP) or dioctyl adipate (DOA). The particulate material in that case may typically serve as a pigment for the plasticiser. An example of a particulate material used in such compositions is calcium carbonate.

In the case of particulate sols for use as additives for imparting anti-block and/or abrasion resistance properties to polymers, or for providing particulate dye receptor sites in the polymers to enhance coloration on dying, the non-aqueous medium may be predominantly or totally a sol-sustaining organic liquid carrier such as, for example, a glycol, e.g. ethylene glycol. Examples of particulate materials used in such compositions are silica and calcium carbonate, the particles being of a size suitable for sol formation in the liquid carrier. The polymers may include, for example, polyesters such as PET (polyethylene terephthalate), polyolefins, polyamides and generally other polymers suitable for use in films. Particulate sols can be used in the manufacture of polymer films or fibers for a wide range of uses.

In the case of a coating composition such as a paint, the non-aqueous medium may for example be predominantly or totally a suitable millbase solvent or a resin/solvent mixture. For example, organic solvents such as alkyd resins, alcohols such as n-loweralkyl alcohols (e.g. n-butanol), ketones such as diloweralkyl ketones (e.g. methyl ethyl ketone), esters such as loweralkyl loweralkanoates (e.g. butyl acetate), mixed organic solvents such as white spirit, aromatic organic solvents such as mono-, di- or tri-loweralkyl benzenes (e.g. toluene or xylene), glycols, or any combination thereof may be used, the term “loweralkyl” and like terms referring preferably to straight or branched alkyl groups having from 1 to about 6 carbon atoms. Examples of particulate materials used in such compositions are metal oxides, alkaline earth metal carbonates, metal hydroxides, kaolin, etc.

### BRIEF DESCRIPTION OF THE DRAWINGS

Embodiments of the present invention will now be described by way of example only, and without limitation, with reference to the following Examples and the accompanying drawings, in which:

FIG. 1 shows the relationship between viscosity and solids content of the non-aqueous dispersion of Example 1(a);

FIG. 2 shows the viscosity of the non-aqueous dispersions described in Example 1(b); and

FIG. 3 shows the relationship between viscosity and shear rate for the non-aqueous dispersions described in Example 3.

### EXAMPLES AND DETAILED DESCRIPTION OF THE DRAWINGS

### Example 1

### (a) Comparison

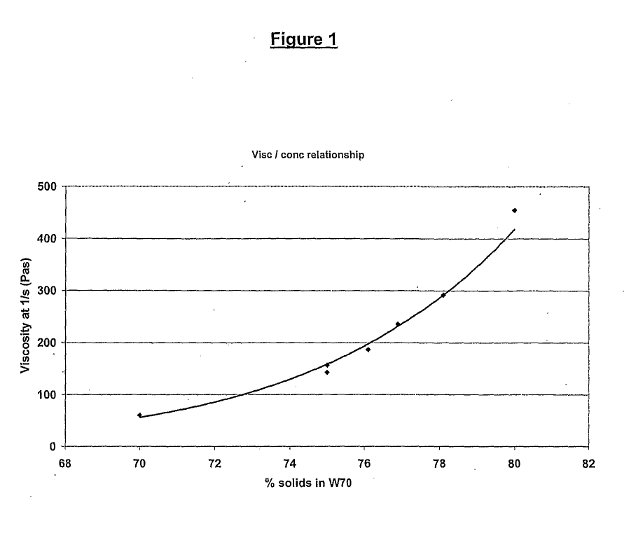

A commercially available ground marble, surface treated with stearic acid (nominally 0.9 wt %) and having a d₅₀ of 2.4 μm, was used to prepare a series of dispersions at different particulate loadings in a (non-polar) white paraffin mineral oil (Winog 70, available from Wintershall, Salzbergen, Germany). A dispersing agent was not present. The viscosity (in Pa·s) was measured at room temperature on a Bohlin rheometer using a 20 mm cone/plate at a shear rate of 1/sec and the results are illustrated in FIG. 1. These show that the viscosity becomes unacceptably high when the loading exceeds 70 wt %.

### (b) Invention

Modified versions of the dispersions prepared in Example 1(a) above at 75 wt % and 80 wt % loadings were prepared. The preparations in this Example differed from Example 1(a) in that three different dispersants—namely Solsperse 21000 (Lubrizol); Solsperse 3000 (Lubrizol); and Hypermer LP-1 (Uniquema)—were included in the dispersion at a concentration of 1 percent by weight actives.

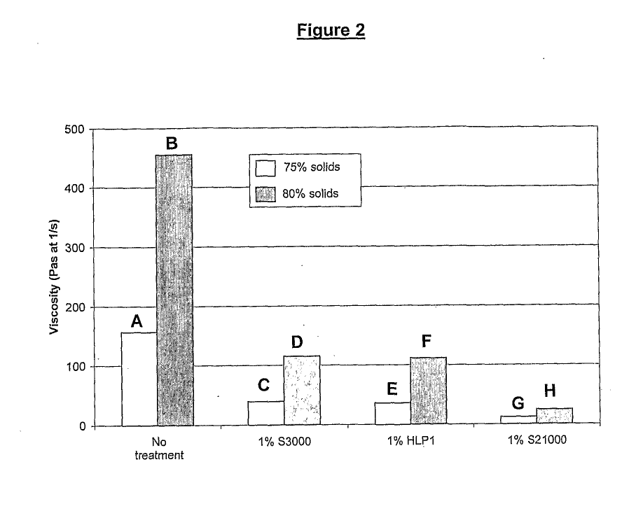

The viscosity (in Pa·s) was measured as above in respect of the two dispersions from Example 1(a)—which contain stearic acid treated particles but no dispersant—and the six modified dispersions—which contain stearic acid treated particles and dispersant—and the results are illustrated in FIG. 2.

In FIG. 2:

Dispersion A is the 75% dispersion from Example 1(a) (no dispersant);
Dispersion B is the 80% dispersion from Example 1(a) (no dispersant);
Dispersion C is the 75% dispersion incorporating 1% Solsperse 3000;
Dispersion D is the 80% dispersion incorporating 1% Solsperse 3000;
Dispersion E is the 75% dispersion incorporating 1% Hypermer LP-1;
Dispersion F is the 80% dispersion incorporating 1% Hypermer LP-1;
Dispersion G is the 75% dispersion incorporating 1% Solsperse 2100; and
Dispersion H is the 80% dispersion incorporating 1% Solsperse 2100.

Dispersions C to H are in accordance with the present invention.

These results illustrated in FIG. 2 show the dramatic reduction in viscosity when the dispersion contains a dispersant.

### Example 2

An untreated ground calcium carbonate identified as Carbonate A having the characteristics set forth in Table 1 below was divided into five samples B to F and each was subjected to surface treatment as described below.

Carbonate B was prepared by coating Carbonate A with stearic acid (70% food grade) at a treat rate of 1 wt % active.

Carbonate C was prepared by coating Carbonate A with Solsperse 2100 dispersant at a treat rate of 0.5 wt % active. The dry powdered mineral was coated in a laboratory high-shear blade mixer (Steele and Cowlishaw).

Carbonates D and E were prepared in the same manner as Carbonate C, but at treat rates of 1.0 wt % and 2.0 wt % active respectively.

Carbonate F was prepared by coating stearate-treated Carbonate B with Solsperse 21000 at a treat rate of 1 wt % actives using a laboratory high-shear blade mixer (Steele and Cowlishaw).

The following physical properties of these Carbonates were analysed:

Moisture pick up (MPU)—percentage increase in mass after 24 hours at 98% relative humidity and at 23° C. For the purposes of this measurement, 98% relative humidity is defined as the humidity of the atmosphere above a saturated aqueous solution of potassium sulfate.

BET surface area (SA) in m²/g
Particle size distribution by Sedigraph 5100
Particle size distribution d₅₀ by Sedigraph 5100

The results are set forth in Table 1 below.

Each treated carbonate was subsequently formed into a 75 wt % dispersion in Winog 70 white paraffin mineral oil (referred to as W70 in Table 1) and the Hegman Gauge value was measured, as well as the viscosity (in Pa·s) at room temperature on a Bohlin rheometer using a 20 mm cone/plate at a shear rate of 1/sec. The results obtained are also set forth in Table 1 below.

TABLE 1

| | MPU | | | Sedigraph wt % | | | | |
|---|---|---|---|---|---|---|---|---|
| | 24 h | Hegman | SA | smaller than | | | d₅₀ | Viscosity in W70 |
| Sample | mass % | μm | m²/g | 2 μm | 1 μm | 0.25 μm | (μm) | (Pa · s @ 1/sec) |
| A | 0.59 | 15 | 4.8 | 72.1 | 38.6 | 1.7 | 1.25 | Too high to measure |
| B | 0.15 | 15 | 5.0 | 72.4 | 41.2 | 6.4 | 1.17 | 445 |
| C | 0.50 | 20 | 4.5 | 72.0 | 40.6 | 5.1 | 1.19 | 2600 |
| D | 0.32 | 15 | 4.4 | 67.5 | 32.5 | 3.7 | 1.38 | 40 |
| E | 0.19 | 20 | 3.4 | 62.1 | 25.1 | 1.9 | 1.57 | 9 |
| F | 0.08 | 20 | 4.2 | 69.8 | 38.4 | 6.0 | 1.24 | 50 |

The double-treated Carbonate F had a lower moisture, pick up than a single-treated product (stearic acid alone). This reduced affinity for moisture is advantageous for an inorganic particulate to be compounded into a non-aqueous or organic system, and this finding is unexpected.

The viscosity of the white oil dispersion of the double-treated Carbonate F was an order of magnitude lower than that of the single-treated Carbonate B. As previously mentioned, there is a continuing need for the viscosity of high-solids non-aqueous dispersions of inorganic particulates to be maintained as low as possible. This extent of viscosity reduction is advantageous and unexpected. Furthermore, the reduced viscosity is maintained even in the absence of the hydrophobising surface treatment agent, provided that an effective amount of the dispersant is used (Carbonates D and E).

Carbonates C, D, E and F and their dispersions are thus in accordance with the present invention.

It will be noted that better dispersion of a mineral in filled polymers is associated with better mechanical properties, surface finish and opacity of the polymer product. Interestingly, good dispersion (low Hegman value) in the results of this Example does not correlate with low viscosity. This suggests that the dispersing agent acts in a way which can significantly lower the viscosity of the dispersion without adversely affecting (i.e. independently of) the quality of the dispersion. This offers potentially significant advantages.

These results suggest that a mineral product treated with an effective amount of a dispersant may disperse better and quicker using less time and energy during compounding and conversion, than a product treated only with a hydrophobising surface treatment agent (e.g. stearic acid). Alternatively, a masterbatch with a higher carbonate loading could be produced using the same time/energy.

### Example 3

A comparison was made between a sample of Carbonate B (coated with stearic acid only) from Example 2 mixed into white paraffin oil (Winog 70) containing dispersant (Solsperse 21000) and a sample of Carbonate F (stearate and Solsperse 21000 coated) mixed into pure white paraffin oil (Winog 70). The solids content of the dispersions in each case was 75% by weight.

This example demonstrates the improvement obtained when the carbonate is pre-treated with the hyper-dispersant (done here dry) as opposed to being added to an oil containing the hyperdispersant. In this sample, carbonate B (as described above) is dispersed into an oil with 1% (by weight of dry carbonate) Solsperse 21000 already present in the oil. Carbonate F is Solsperse 21000 coated and is dispersed into pure oil.

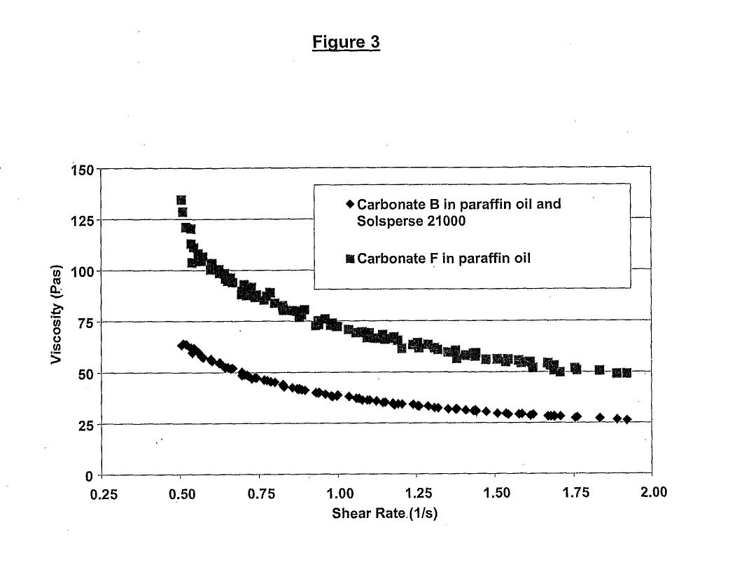

The viscosity (in Pa·s) of the two dispersions was measured at room temperature on a Bohlin rheometer using a 20 mm cone/plate within the range of shear rates 0.25 to 2.00 s⁻¹, and the results are illustrated in FIG. 3.

Both dispersions are in accordance with the present invention.

The data of this and the previous Example indicate that a better performance is achieved if the mineral is dry-mixed with the dispersant rather than introducing the dispersant to the organic liquid separately from the mineral.

The foregoing broadly describes the present invention without limitation. Variations and modifications as will be readily apparent to those of ordinary skill in this art are intended to be covered by the present application and subsequent patent(s).

1: A dispersion of at least one particulate inorganic material, the dispersion comprising at least one non-aqueous liquid medium comprising at least one particulate inorganic material dispersed therein and an effective amount of at least one dispersing agent which serves to maintain the at least one particulate inorganic material in dispersion in the at least one non-aqueous medium, wherein the at least one particulate inorganic material has an average particle size (d₅₀) less than about 9 μm, the at least one particulate inorganic material is present in the at least one non-aqueous medium in an amount greater than about 70% by weight of the dispersion, and the viscosity of the dispersion is less than about 150 Pa·s measured at room temperature on a Bohlin rheometer using a 20 mm cone/plate at a shear rate of 1/sec.

2: A dispersion according to claim 1, wherein the at least one particulate inorganic material is chosen from the group consisting of particulate natural, synthetic, and blended minerals.

3: A dispersion according to claim 1, wherein the at least one particulate inorganic material is chosen from the group consisting of an alkaline earth metal carbonate, a metal sulfate, a metal silicate, a metal oxide, a metal hydroxide, kaolin, calcined kaolin, wollastonite, bauxite, talc, and mica.

4: A dispersion according to claim 1, wherein the at least one particulate inorganic material is chosen from the group consisting of calcium carbonate, dolomite, barite, gypsum, titania, iron oxide, chromia, antimony trioxide, silica, and alumina trihydrate.

5: A dispersion according to claim 4, wherein the at least one particulate inorganic material is calcium carbonate.

6: A dispersion according to claim 1, wherein the at least one inorganic particulate material is a material that has been surface treated with at least one hydrophobising agent.

7: A dispersion according to claim 6, wherein the long hydrophobic hydrocarbon chains are alkyl or alkenyl chains having at least about 12 carbon atoms in the alkyl or alkenyl chain.

8: A dispersion according to claim 6, wherein the at least one hydrophobising agent is selected from the group consisting of fatty acids incorporating the long hydrophobic hydrocarbon chains and amines incorporating the long hydrophobic hydrocarbon chains.

9: A dispersion according to claim 8, wherein the at least one hydrophobising agent is selected from the group consisting of stearic acid, oleic acid, lauric acid, and palmitic acid, as well as salts thereof.

10: A dispersion according to claim 1, wherein the at least one dispersing agent is at least one hyperdispersant.

11: A dispersion according to claim 10, wherein the at least one hyperdispersant comprises polymerised hydroxycarboxylic acids containing at least about 12 carbon atoms in each chain and one or more anchor moieties which associate with sites of the particle surface or of a synergist molecule anchored to the particle surface.

12: A dispersion according to claim 10, wherein the at least one hyperdispersant comprises one or more poly-hydroxy-(long chain fatty acids), wherein the long chain fatty acids are alkyl or alkenyl carboxylic acids having at least about 12 carbon atoms in the alkyl or alkenyl chain.

13: A dispersion according to claim 12, wherein the at least one hyperdispersant is a polyhydroxystearic acid or a salt thereof.

14: (canceled)

15: A dispersion according to claim 6, wherein the at least one inorganic particulate material is a material that has been surface treated with at least one hyperdispersant.

16-19. (canceled)

20: A dispersion according to claim 1, which consists essentially of the at least one particulate inorganic material, the at least one non-aqueous liquid medium, and the at least one dispersing agent, together with less than about 15% by weight of other components.

21: A dispersion according to claim 1, wherein the moisture pick-up of the at least one particulate inorganic material is less than about 0.15%.

22. (canceled)

23: A dispersion according to claim 1, wherein the at least one particulate inorganic material has an average particle size (d₅₀) less than about 8 μm.

24-25. (canceled)

26: A dispersion according to claim 23, wherein the at least one particulate inorganic material has an average particle size (d₅₀) less than about 5 μm.

27: A dispersion according to claim 23, wherein the at least one particulate inorganic material has an average particle size (d₅₀) between about 0.1 μm and about 5 μm.

28-29. (canceled)

30: A dispersion according to claim 26, wherein the at least one particulate inorganic material has an average particle size (d₅₀) less than about 2 μm.

31: A dispersion according to claim 30, wherein the at least one particulate inorganic material has an average particle size (d₅₀) less than about 1 μm.

32: A dispersion according to claim 1, wherein the at least one particulate inorganic material has an average particle size (d₅₀) greater than about 0.1 μm.

33. (canceled)

34: A dispersion according to claim 1, wherein the viscosity of the dispersion is less than about 100 Pa·s.

35. (canceled)

36: A dispersion according to claim 34, wherein the viscosity of the dispersion is less than about 70 Pa·s.

37: A dispersion according to claim 36, wherein the viscosity of the dispersion is less than about 40 Pa·s.

38: A dispersion according to claim 1, wherein the at least one particulate inorganic material has a BET surface area greater than about 2 m²/g.

39: A process for the preparation of the dispersion according to claim 1, which comprises admixing the at least one particulate inorganic material with the at least one non-aqueous liquid medium in the presence of the at least one dispersing agent.

40: A process according to claim 39, wherein the at least one non-aqueous liquid is blended with the at least one particulate inorganic material, with the at least one dispersing agent being introduced as a pre-treatment of the at least one particulate inorganic material.

41: A process according to claim 39, wherein the at least one non-aqueous liquid is blended with the at least one particulate inorganic material, with the at least one dispersing agent being included in the at least one non-aqueous liquid prior to blending with the at least one particulate inorganic material.

42. (canceled)

43: Use of a dispersion of at least one particulate inorganic material according to claim 1, in or for the preparation of products selected from polymers and articles made from polymers, sealants, adhesives, caulks, coatings, toners and inks.

44. (canceled)

45: A product selected from polymers and articles made from polymers, sealants, adhesives, caulks, coatings, toners and inks, comprising the dispersion of claim 1.

46: A substantially dry inorganic particulate material having an average particle size (d₅₀) less than about 9 m, the material being surface-treated with an effective amount of at least one dispersing agent such that, when dispersed in at least one non-aqueous liquid medium in an amount greater than about 70% by weight of the dispersion, the particulate inorganic material is maintained in dispersion in the non-aqueous medium, the viscosity of the dispersion being less than about 150 Pa·s measured at room temperature on a Bohlin rheometer using a 20 mm cone/plate at a shear rate of 1/sec.

47-59. (canceled)
